(19) United States
(12) Patent Application Publication
(10) Pub. No.: US 2008/0154670 A1
(43) Pub. Date: Jun. 26, 2008

(54) Pillow Certification System

(76) Inventor: Matthew S. McAlhaney, Beaufort, SC (US)

Correspondence Address: NEXSEN PRUET, LLC, P.O. BOX 10648, GREENVILLE, SC, 29603, US

(21) Appl. No.: 11/814,991

(22) PCT Filed: Mar. 8, 2006
(86) PCT No.: PCT/US06/08408

§ 371 Date: Jul. 27, 2007

Related U.S. Application Data
(60) Provisional application No. 60/659,517, filed on Mar. 8, 2005.

(51) Int. Cl. A47G 9/10; B23P 11/00; G06Q 10/00; G06Q 99/00

(52) U.S. Cl. 705/7; 5/652; 705/1

(57) ABSTRACT

The present invention is a pillow certification system and method for using the certification system. The purpose of the system is to make it easier for consumers to make choices regarding their selection of a pillow and to provide retail stores and hotels/motels with a convenient and personalized feature to attract business. The system comprises pillows manufactured to meet a matrix of specifications so that each pillow has the requisite values of each characteristic specified, each pillow having a certification marking affixed thereto that identifies the specified characteristics of that pillow. Hotels can use the certification system to give each guest a pillow having the characteristics that guest prefers.

### BACKGROUND OF THE INVENTION

People generally spend up to one third of their lives sleeping. The quality of their sleep has a direct relationship to their well-being, their health, their productivity, and their enjoyment of their waking hours. Sleep quality itself depends on a number of factors. One of these factors is the pillow used.

Given choices, people may prefer a pillow that is larger or smaller, softer or firmer, and more or less resilient. Those with allergies may strongly prefer pillows made of hypoallergenic materials. For our homes, we can choose the pillow we prefer. When traveling, we may not always have a choice. Hotels will sometimes have hypoallergenic pillows available for guests who request them but otherwise, the pillow in the room is the only pillow for the guest to use.

The hotel business is a competitive one. In order to keep occupancy high, hotels have increased the amenities for guests in the past several decades. Hotels now offer, in addition to an array of toiletries, a morning newspaper, in-room coffee service, a continental breakfast and perhaps a bathrobe, well-equipped gyms and high-speed internet access. This trend will no doubt increase.

Certification systems are used to simplify consumer decision-making. Individual consumers may not know when an electric appliance has a safe design, for example, but if there is an Underwriters Laboratories tag on the power cord of the appliance, consumers will rely on that indicia and trust that the appliance has met requirements established by those who know when designs are safe and assume that the design of that appliance is safe. As another example, when choosing a movie to watch, parents may rely on the rating of the movie rather than pre-screen it before allowing their children to watch the movie. They will assume that the movie with a “general” rating is suitable for children to watch and does not contain adult content or violence or other unsuitable subject matter.

### SUMMARY OF THE INVENTION

The present invention is a pillow certification system and method for using the certification system. The purpose of the system is to make it easier for consumers to make choices regarding their selection of a pillow and to provide retail stores and hotels/motels with a convenient and personalized feature of importance to their clients in order to attract business.

The pillows are sleeping pillows, that is, pillows used to support the head of the user when sleeping as opposed to decorative pillows. The certification system includes the manufacturing of pillows by at least one approved source, which pillows have characteristics in a pre-selected range of values that are preferred by a portion of likely users. These characteristics would include softness and loft of the pillow, for example.

Using several characteristics (softness, loft, size, materials, etc.), a matrix of specifications for pillows can be created. For simplicity, each combination of characteristics on the matrix can be given a unique code name or number or icon that users may come to know represents a pillow made according to a specification they prefer. For example, a firm, standard-size, hypoallergenic pillow made of foam may be given the designation HA001 or a more easily decoded designation or even an icon or name. Consumers who prefer this type of pillow can refer to it by that designation, if they know it. Manufacturers of pillows can be trained and certified as able and willing to follow these specifications.

The softness and loft elements of the specification, because of their qualitative nature, would be subject to wide variation of manufacturer interpretation if it is not made quantifiable. The pillow certification system includes a testing method and apparatus to assure that these important characteristics of each pillow's specification can be consistently replicated by a manufacturer.

For the purposes of illustrating the present pillow certification system, a pillow's firmness can range from 1, very soft, to 5, very firm, while the loft is characterized as high, medium or low. The softness numbers correspond to the average of scores in three “softness” tests or trials, while the loft numbers correspond to the average of scores in three “loft” tests or trials. Both these tests are described below:

Softness Test: Subject pillow is positioned under test apparatus, described more fully below, fitted with the softness test weight, a sphere of 23 cm diameter and weighing (including the weight of apparatus attachment arm) 5 kg, so that the weight is just in contact with the pillow. The weight is allowed to fall from its start position, zero, to rest. The connector arm holding the test weight is calibrated in half-centimeter increments from 0 to 30 cm. Five seconds after release of the test weight note is made of the distance dropped, indicated by a pointer affixed to the apparatus frame where it holds the control arm. See illustration. The apparatus is then reset, the pillow fluffed and positioned, and another test is run. The average distance dropped after three tests determines the softness of pillows constructed by the specification of that one tested. This test must be performed periodically to assure components, especially fill, are sufficiently uniform from batch to batch to yield pillows of comparable softness over the course of a production run.

Loft Test: Employing the same apparatus, but this time fitted with a 1 kg cylindrical weight (this 1 kg includes the weight of the control arm) having a cross sectional area of 16 square centimeters (cylindrical weight not shown). Subject pillow is positioned under the apparatus so that the weight is just in contact with the pillow. The weight is allowed to fall from its start position, zero, to rest. Five seconds after the release of the test weight note is made of the distance dropped. The test weight is then raised clear of the pillow for 10 seconds, then lowered slowly until it barely contacts the pillow again, in the same place as was depressed by the weight. Note is made of that position. The apparatus is then reset, the pillow is fluffed and positioned, and another test is run. The average distance RECOVERED (i.e. distance dropped in the first phase of the test, less the distance from zero noted after the 10-second recover time) after three tests determines the loft of pillows constructed by the specification of that one tested. This test must be performed periodically to assure components, especially fill, are sufficiently uniform from batch to batch to yield pillows of comparable loft over the course of a production run.

The pillow certification system can then be offered to consumers directly through retail outlets to shoppers and indirectly through hotels and motels to those booking rooms. Just as guests at hotels may have their choice of “smoking” and “no smoking” rooms, “single king” or “two double beds”, so too can they be given choices of the type of pillow they prefer. The guest at the time of booking or on checking in, can specify a “HA001” (to use the example above) to specify a firm, hypoallergenic, standard-size pillow.

### BRIEF DESCRIPTION OF THE DRAWINGS

In the drawings,

FIG. 1 is a perspective view of a pillow with a certification label according to a preferred embodiment of the present invention.

FIG. 2 is a detailed view of the label on the pillow of FIG. 1.

FIG. 3 is a perspective view of the test apparatus for measuring softness with a detailed view of the connection between the weight and the arm, according to a preferred embodiment of the present invention.

### DETAILED DESCRIPTION OF PREFERRED EMBODIMENTS

The present invention is a certification system for sleeping pillows and a method for using the certification system. The term “pillows” will be used to indicate sleeping pillows, that is, pillows used by consumers when sleeping to rest their heads.

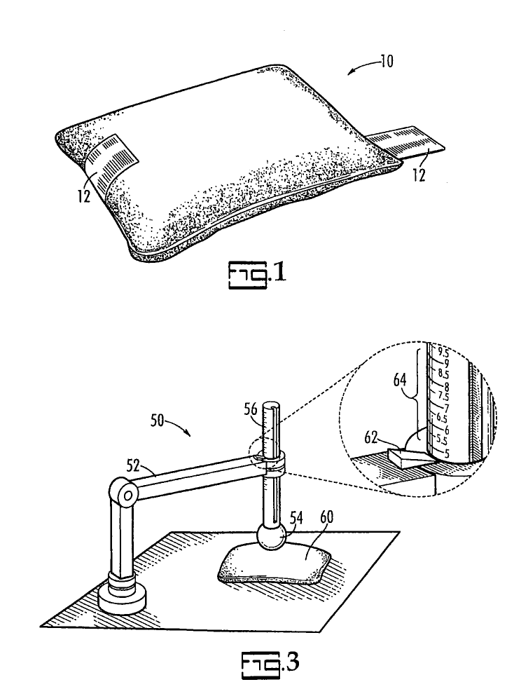

FIG. 1 is a perspective view of a typical pillow 10. Tags 12 are attached to it in two places but only one is sufficient. Tags 12 describe pillow 10 in context of the range of preferences of pillow characteristics.

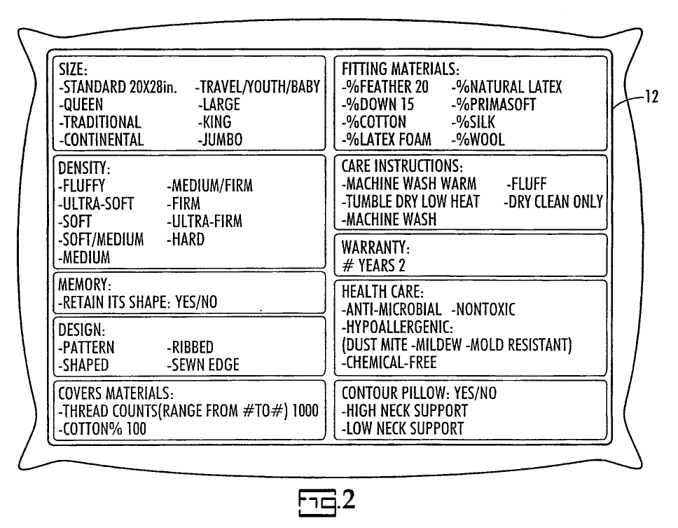

FIG. 2 illustrates tag 12 in greater detail. In this example, the characteristics of pillow 10 are indicated in the lists of characteristics by bolded letters. In this embodiment, the user can easily see other characteristics that are available, such as a large pillow rather than a standard 20×28 inch pillow. This approach allows users to know what other characteristics are available so that they may select their own combination of characteristics or different characteristics from their preliminary selection.

FIG. 3 illustrates the test apparatus 50 comprising a control arm 52 with a weight 54 slidably held on the end of a calibrated shaft 56. Shaft 56 and weight 54 are lifted, pillow 60 is fluffed and positioned under weight 54, and then weight 54 and shaft are lowered as described above for softness and loft. The position of a pointer 62 on control arm 52 with respect to calibrations 64 on shaft 56 determine the softness and loft of pillow 60, as shown in the detailed view of the connection between shaft 56 and control arm 52.

The softness and loft of a pillow are reflective of the contents of the pillow covering; that is, the type of content, the amount of content, the blend of different types of content. Content, in this sense, means the materials of which the sleeping pillow is made, particularly the materials inside the covering or the “fill.” Pillows are currently made of various materials including foam, cotton batting, synthetic batting, and down feathers. These materials are treated in well-know ways prior to use in order to clean them and enable them to resist mold and bacterial growth.

By modest experimentation, and by using test apparatus 50, the softness and loft of these materials and combinations of these materials in different quantities can be determined and specific characteristics can be achieved by using the right materials in sufficient quantities. Those characteristics, softness and loft, would be quantifiable by a measuring device, such as test apparatus 10, and the method for verifying the characteristics correspond to a particular specification for manufacturing the pillow is a part of the present inventive concept. A certification marking, such as a tag or label, would be attached to the pillow made according to that specification that identifies the relative softness and loft of the pillow either by a word or short phrase or by an icon. Other characteristics are also included, as desired, such as size and whether the contents are hypoallergenic.

Other ways of presenting characteristics can be used as well as a shorthand expression for a specific combination of characteristics. Just as the letters “PG” for a certification system for movies signals “parental guidance” and, further, a list of characteristics of a movie adjudged to correspond to the PG label, so too can a pillow have a code that signifies its size, density, resilience (memory), design, cover material, filling material, washing instruction, warranty, health care information, and contour.

The present pillow certification system thus comprises a range of pillows made to meet various characteristics and set of labels affixed to each such pillow in the range of pillows to inform the consumer of the characteristics that each particular pillow in the range of pillows was manufactured to meet.

Hotels can use the present pillow certification system to improve the satisfaction of guests who stay at that hotel. Particularly in resorts and at hotels where guests typically stay for multiple nights, the guest, either upon checking in or when making a reservation can specify the type of pillow desired by using the certification system. Initially, guests may merely make a selection from the range of characteristics of each category. Eventually, a guest may know the code designation for his or her preferred pillow and be able to request it by code or name. Furthermore, the hotel will stock in suitable quantities the types of pillows that are generally requested by guests so as to have at least the most popular types. The hotel may also offer to sell the pillow to the guest in the same way some hotels offer to sell bathrobes.

The present certification system, when used by hotels, can increase guest loyalty, occupancy rate, and bookings.

The present certification system can also simplify consumer shopping. Consumers familiar with the certification system can buy the type of pillow they want more easily. Particularly for those who shop on the internet, where examining the goods is difficult to do in other than a superficial way, the present certification system can make it much easier to select pillows for purchase in a more reliable way, having confidence that the pillow selected will be like previous pillows purchased having the same characteristics as indicated by the same code or name.

What is claimed is:

1. A sleeping pillow, comprising:
a pillow covering filled with contents selected to give said pillow pre-selected characteristics of loft and softness; and
a certification marking carried thereon, said certification marking including indicia indicative of said pre-selected characteristics of said pillow.

2. The sleeping pillow as recited in claim 1, wherein said pre-selected characteristics are determined by measurement standards.

3. The sleeping pillow of claim 1, wherein said pillow has a characteristic of size, and wherein said certification marking indicates said size of said pillow.

4. The sleeping pillow of claim 1, wherein said pillow has a characteristic of being hypoallergenic when made of hypoallergenic materials, and wherein said certification marking indicates that said pillow is made of said hypoallergenic materials.

5. A method for making pillows comprising the steps of:
establishing a matrix of specifications for pillows, each element of said matrix being a different specification, by identifying plural characteristics for pillows wherein each characteristic of said plural characteristics has a range of pre-selected values and each specification composed of one value of said pre-selected values for said each characteristic;
making plural pillows by placing contents in coverings so that each pillow meets one specification of said matrix; and
placing a certification marking on said each pillow visible to a user indicating said specification said pillow meets.

6. The method as recited in claim 5, wherein said plural characteristics include loft and softness.

7. The method as recited in claim 5, wherein said plural characteristics include size and hypoallergenic contents.

8. The method as recited in claim 5, wherein said plural characteristics are measurable by testing.

9. A method for using a pillow certification system wherein plural pillows are manufactured to have specific values within a range of values for each characteristic of plural characteristics, said specific values of said each characteristic being indicated in a certification marking carried by each pillow of said plural pillows, said method comprising the steps of:
providing said plural pillows to a hotel; and
allowing hotel guests on checking into said hotel to select a pillow having a specific value for said each characteristic.

10. The method as recited in claim 9, further comprising the step of selling said selected pillow from said hotel.
